(19) United States
(12) Patent Application Publication
(10) Pub. No.: US 2017/0006330 A1
(43) Pub. Date: Jan. 5, 2017

(54) MANAGEMENT OF THE OPERATION OF A CONTROL MODULE

(71) Applicant: ORANGE, Paris (FR)

(72) Inventors: Fabrice FONTAINE, Geveze (FR); Simon GLOANCE, Rennes (FR); Fabrice BARANSKI, Chantepie (FR)

(21) Appl. No.: 15/104,230

(22) PCT Filed: Dec. 12, 2014
(86) PCT No.: PCT/FR2014/053319

§ 371 Date: Jun. 13, 2016

(30) Foreign Application Priority Data
Dec. 20, 2013 (FR) 1363140

(51) Int. Cl. H04N 21/422; H04N 21/472

(52) U.S. Cl. CPC H04N 21/42204; H04N 21/47202; H04N 21/43637

(57) ABSTRACT

The invention relates to a method of managing the operation of a control module (TCD) suitable for controlling a device (DEC) suitable for delivering services, the module (TCD) comprising a processor (CPU) and a plurality of control elements (GRS, ACC, CT, CLV) suitable for issuing commands, the method being characterized in that it comprises a step of modifying its operation as a function of the service delivered by the device.

The invention relates to a method of managing the operation of a control module.

A control module is a device used for manipulating some other device remotely, by cable, infrared, radiowaves, etc., the manipulation taking place via a set of commands available on the control module.

The control module may be a physical and/or software resource. A physical control module is typically a remote control suitable for controlling a device that is represented in the description below by means of a data stream receiver. A software control module may for example be a man-machine interface; this type of interface is available for viewing content on a computer; specifically, more and more content (video-on-demand (VOD), television-on-demand (TVOD)) can be read on a computer, a tablet, or on similar devices.

The receiver is also a physical and/or software resource. By way of example, a physical receiver is a decoder, a gateway, a television set, a Hi-Fi system, etc. By way of example, a software receiver is a computer application of the video-on-demand, television-on-demand, etc. type.

The control module has a plurality of control elements (keyboard, gyroscope, magnetometer, fingerprint sensor, etc.) that are electrically powered by means of a source of energy such as optionally rechargeable batteries, etc.; which elements serve to control a particular function of the receiver.

The inventors have observed that the control module operates in isolation, in the sense that all of its commands are one-way; they are sent from the control module to the data stream receiver.

The control module therefore cannot adapt its operation to its environment. For example, by operating in isolation in this way, it can happen, amongst other things, that its consumption of electricity is excessive since the control elements (gyroscope, accelerometer, etc.) are powered continuously.

The invention seeks to improve the situation.

To this end, the invention provides a management method for managing the operation of a control module suitable for controlling a device suitable for delivering services, the module comprising a processor and a plurality of control elements suitable for issuing commands, the method being characterized in that it comprises a step of modifying its operation as a function of the service delivered by the device.

The service(s) being delivered thus has/have an influence on the operation of the control module. The control module thus no longer operates independently of the service delivered by the controlled device.

In a particular implementation, the control module may receive data from the outside in association with the service delivered by the device. The data received by the control module is representative of a type of data stream received by the device. In this way, the behavior of the control module may be modified as a function of the type of stream, for example depending on whether the stream is a video stream, a game, a live television program, etc. The data may come from any origin, e.g. a digital decoder, a gateway, a television TV, a services platform PF, etc.

By means of the invention, the control module is responsive to its environment. It can be seen below that the received data has an influence on the operating state of the module while it is switched on; and in particular on the electrical state of the modules, on the operating state of the modules, etc.

It can be seen in the description that the data suitable for modifying the operation of the control module may equally well be a command and/or information data that the control modules can interpret on receiving it.

The modules are electrically powered from a source of energy. In yet another particular implementation of the invention, which may be implemented as an alternative to or together with the preceding implementation, the control elements are powered selectively as a function of the service delivered by the device. In this way, and depending on the type of stream being received (game, video, etc.) by the device, certain control elements are powered while others are unpowered or put on standby. The energy consumption of the remote control is thus reduced correspondingly and its battery life lengthened.

A control module includes control elements suitable for issuing commands at a given rate. In yet another particular implementation of the invention, which may be implemented as an alternative to or together with the preceding implementations, the rate at which commands are issued by said control element is modified as a function of the service delivered by the device. In this way, depending on the stream being received, the rate is modified so as to match the data stream, or more generally the service delivering the stream. It is explained that this characteristic applies more particularly to control elements that issue commands spontaneously at a given rate; by way of example, these elements are a gyroscope, an accelerometer, etc.

It should be recalled that the term “service” relates to a service of supplying a data stream. The data stream in question relates to data of any type;

specifically multimedia data (photos, video, etc.), data relating to an on-line game, etc.

In yet another particular implementation of the invention, that may be implemented as an alternative to or together with the preceding implementation, the device is a data receiver suitable for receiving data representative of a service. By way of example, the receiver may be a digital decoder, a home gateway (or router), etc.

In a hardware aspect, the invention provides a control module suitable for controlling a device suitable for delivering services, the module comprising a processor and a plurality of control elements suitable for issuing commands, the module being characterized in that it includes receive means suitable for receiving data associated with the delivered service and modification means suitable for modifying its operation as a function of the received data.

In another hardware aspect, the invention provides a computer program suitable for being performed by a control module as defined above, said program comprising code instructions that, when the program is executed, perform the steps defined in the above-defined method.

In another hardware aspect, the invention provides a management module suitable for communicating with a control module suitable for controlling a device suitable for delivering services, the management module being characterized in that it includes means for transmitting data associated with the delivered service, said data being suitable for being taken into account by the control module to modify the behavior of the control module.

In another hardware aspect, the invention relates to a device, in particular a receiver of data representative of a service, characterized in that it includes a management module as defined above.

In another hardware aspect, the invention provides a service platform suitable for delivering data streams to a device, the platform being characterized in that it includes a management module as defined above.

Finally, in another hardware aspect, the invention provides a system including a device and a control module suitable for communicating with each other via a communication network, the system being characterized in that it comprises a control module as defined above and a management module as defined above.

The invention can be better understood on reading the following description given by way of example and made with reference to the accompanying drawing, in which:

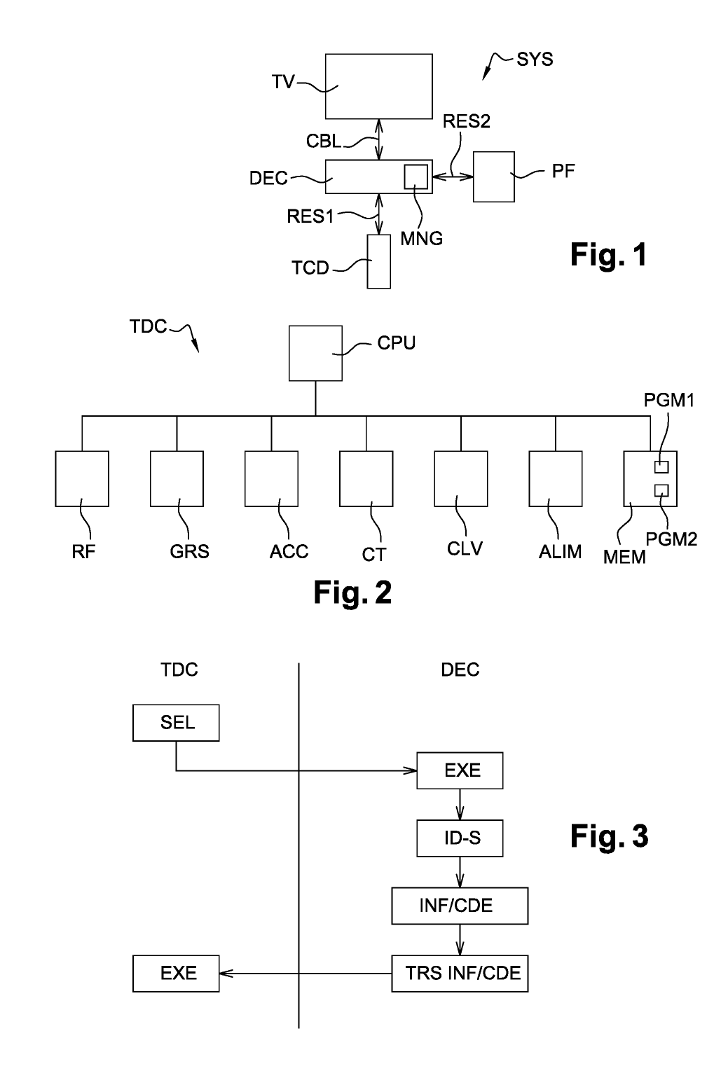

FIG. 1 shows a computer system for illustrating an implementation of the invention;

FIG. 2 is a diagrammatic view of circuits present in a control module; and

FIG. 3 is a diagrammatic view of steps performed for performing the invention.

### DETAILED DESCRIPTION OF AN IMPLEMENTATION ILLUSTRATING THE INVENTION

FIG. 1 shows a system SYS comprising a control module TCD, a device DEC, a television TV, and a services platform PF.

In this example, the device includes a decoder and a gateway (or router). The decoder and the gateway have hardware architecture equivalent to a computer; they are not described in detail herein in order to simplify the description of the invention.

One or more services (games, video) may be stored on the device. The services may also be stored on a network that is accessible by the device. In any event, the device delivers or contributes to delivering a service.

In this example, the services platform PF has a plurality of services such as accessing television channels, accessing multimedia contents (video-on-demand, TV on demand, etc.), on-line games, etc.

The platform may be constituted by a plurality of entities so as to offer services that are distributed within the network RES2.

In this example, the control module TCD communicates with the decoder DEC via a first network RES1 of the ZigBee type. For this purpose, the control module and the decoder are fitted with respective ZigBee modules. It should be recalled that ZigBee is a low power wireless technology; it enables messages to be exchanged over a radio channel in compliance with the ZigBee protocol. The ZigBee protocol is a high level protocol enabling small low-power radios to communicate on the basis of the IEEE 802.15.4 standard for networks of personal size (wireless personal area network: WPAN).

In this example, the decoder DEC is connected by a cable CBL to the television TV. By way of example, the cable is an HDMI cable.

The decoder DEC communicates with the platform PF via a second communication network RES2, which may be of any type, e.g. ADSL, fiber, etc.

In this example, the decoder is suitable for delivering a service made available by the platform.

FIG. 2 is a diagrammatic view of circuits present in the control module TCD.

The control module TCD includes a processor CPU and a plurality of modules including control elements. In this example, the modules include:
receive means RF suitable for receiving data; in this example, these receive means are represented by a radio frequency ZigBee module (RF4CE) for communicating with the decoder;
a storage module MEM for storing data; and
the following control elements: a gyroscope GRS; an accelerometer ACC; a keypad CT, e.g. keys situated on one of the faces of the control module; and a keyboard CLV, e.g. keys situated on an opposite face of the control module.

The control modules and elements, and the processor are powered by a power supply ALIM, such as an optionally rechargeable battery.

The modules are installed in a single device and they are connected together by means of a bus. It should be recalled that the function of a bus is to transfer digital data between the various circuits of a computer. In this example, the bus in question includes a data bus and a control bus.

In this example, it should also be observed that the above-described memory module is a permanent memory e.g.

of the read only memory (ROM) type and that the control module also includes a corresponding random access memory (RAM), not shown, that is used for storing in non-durable manner calculation data used in particular when performing the method.

In the invention, the control module does not only issue commands; it can also receive data suitable for being taken into account in the operation of the module. In other words, the received data may modify the way the module operates. Examples below illustrate the principle of the invention.

For example, it can be seen below that the received data influences the management of the power supply to the modules; for example, the supply of power to the modules is managed selectively. In other words, a power supply management module, represented by means of a program PGM1 stored in the memory MEM of the control module, serves selectively to activate or deactivate the supply of power to the modules.

In another example, it can also be seen that the received data may give rise to a change in a rate at which data is sent from a control element such as the gyroscope GRS, the accelerometer ACC, a magnetometer, etc.

The system includes a management module MNG suitable for determining the future behavior of the control module. In this example, the management module MNG is a computer program. The management module MNG may be located anywhere within the system. In this example, this module is in the decoder DEC.

As a function of the selected service, the management module MNG is capable of deducing the future behavior to be applied to the control module TCD. For this purpose, the module identifies the service, and once it has been identified, it supplies data representative of the service to the control module TCD, i.e. information data or one or more commands. Thereafter, the control module TCD (or more precisely the processor CPU) executes the command or interprets the information data, as the case may be, and modifies its operation accordingly.

By way of example, the information data may be an identifier that is subsequently interpreted by the processor CPU in order to deduce which command modules should be activated/deactivated. By way of example, the identifier in question is a service identifier.

Below, it is assumed that the management module MNG for managing future behavior of the control module is situated in the decoder. This presents the advantage of communicating directly with the control module. The module could also be in the remote control.

Three implementations are described with reference to FIG. 3. FIG. 3 shows the control module TCD and the stream receiver DEC together with the data exchanges that take place between them in the three implementations. The steps are as follows:

During a first step SEL, the user uses the control module to select a service. Several commands may be selected in succession.

The decoder DEC receives the successive commands, and executes them, EXE.

At this stage, the management module MNG deduces therefrom the type of service ID-S.

Thereafter, the decoder DEC deduces information data INF or a command CDE. Depending on the selected implementation, a correspondence table may be used to find the information data INF or the command CDE, as a function of the type of service.

In this example, after the information data INF or the command CDE has been obtained, it is transmitted to the control module TCD. In this example, this transmission takes place over the first network RES1. Nevertheless, some other network or channel could be used for transmitting this information data or command.

The information data INF or the command CDE could also be obtained personally by the user. A user seeking to access a game, or other services, could select a key (not shown) of the control module TCD that is provided for this purpose. In this configuration, the management module MNG could be situated in the control module.

On receiving the information data and/or the command, the control module TCD modifies its operation, if necessary, by executing the command it has received or by taking account of the information data. This execution or taking into account are given reference EXE in FIG. 3.

A first implementation is described below in which the service used is a television-on-demand service.

It is assumed that this service requires the use of the following elements from among all of the available control elements:
the keypad CT, e.g. situated on one of the faces of the control module; and
the keyboard CLV, e.g. situated on an opposite face of the control module; and
that it does not require use of the gyroscope GRS or of the accelerometer ACC.

The steps relating to this first implementation are as follows:
During a first step SEL, the user selects a television program via the television-on-demand service. Selection takes place by selecting keys on the keypad CT1 of the control module. For this purpose, the user may for example act on the control module to select a key representing a menu; Thereafter the user selects the desired service from a menu displayed on the screen.

The decoder DEC receives the successive commands and executes them, EXE.

At this stage, the management module MNG knows the type of service ID-S.

In this example, the decoder stores a correspondence table in which a service type ID-S corresponds to the identifiers of control elements that are to be powered and/or of control elements that are not to be powered.

In this example, after identifying the correspondence, information data including the identifiers of the control elements to be activated and/or deactivated is transmitted to the control module so that only some of the control elements are powered by the battery ALIM. Specifically, only the keypad CT and the keyboard CLV are powered electrically. Conversely, the other control elements GRS and ACC are not powered.

In a second implementation, the service is an on-line game.

It is assumed that, from among the control elements available, this game service requires the use of the keyboard CLV, e.g. situated on the opposite face of the control module; of the gyroscope GRS, and of the accelerometer ACC, but does not require the use of the keypad CT.

The steps relating to this second implementation are as follows:

During a first step, the user selects a game by means of the control module TCD. For this purpose, the user acts on the control module to select, for example, a key representative of a menu; thereafter the user selects the desired service from the menu displayed on the screen of the television TV.

The decoder receives the successive commands and executes them, EXE.

At this stage, the management module MNG knows the type of service ID-S.

The decoder stores a correspondence table. Unlike the first implementation, in this second implementation the table stores the types of service and the respective commands to be transmitted to the control module for execution.

In this example, after identifying the correspondence, a command CDE is sent to the control module TCD so that only some of the control elements are powered by the battery ALIM. Specifically, only the following elements are powered, namely: the keyboard CLV, e.g. situated on the opposite face of the control module; the gyroscope GRS, and the accelerometer ACC are all electrically powered. Conversely, the other control elements are not powered, i.e. the keypad CT.

In a third implementation, the command from the decoder may be associated with modifying a rate for sending commands from the control module.

Among the control elements, certain elements issue commands at given rates. For example, during a game, the gyroscope provides information about the positions of the module in three-dimensional space at a given rate. At present, a gyroscope issues positions at a fixed rate of about 100 Hz. However, certain games require rates of about 60 Hz or 50 Hz. The invention makes it possible to modify this rate as a function of the game selected by the user.

In all of the implementations described, once use of the service has come to an end, the operation of the control module can be modified once more; for example, if no service is in use, the control module may switch to a standby state.

As mentioned above, the control module TCD may be a program stored in memory, and the stream received may be an application such as a television-on-demand application. The control module is displayed on a screen, e.g. a touch screen that can be operated with the fingers.

When the control module receives information data or a command, the control module can modify its operation by inhibiting certain commands on the screen. The resulting inhibition prevents a key in question being selected.

By way of example, consideration is given to selecting a data stream corresponding to a television-on-demand program.

At present, television-on-demand programs may be preceded by broadcasting advertising. Often, the advertising organizations from which the advertising comes seek to ensure that a user receiving the advertising cannot use the control module to actuate fast forward and accelerate the playback of the advertising in order to access the program more quickly.

In another variant, the invention can make provision to modify its operation by inhibiting keys of the control module displayed on the screen. This situation can be transposed to the physical control module in the sense that inhibition is replaced by not electrically powering the control element in question.

It should be observed that the various implementations described above may be implemented in isolation or in combination.

Finally, it should also be observed that the terms “module” and “means” can correspond equally well to a software component or to a hardware component or to a combination of hardware and software components, a software component itself corresponding to one or more computer programs or subprograms or more generally to any program element suitable for performing a function or a set of functions as described for the modules and means in question. Likewise, a hardware component corresponds to any hardware element of a set of hardware elements and suitable for performing a function or a set of functions for the module in question (integrated circuit, smart card, memory card, etc.).

1. A management method for managing the operation of a control module (TCD) suitable for controlling a device (DEC) suitable for delivering services, the module (TCD) comprising a processor (CPU) and a plurality of control elements (GRS, ACC, CT, CLV) suitable for issuing commands, the method being characterized in that it comprises a step of modifying its operation as a function of the service delivered by the device.

2. A management method according to claim 1, characterized in that the control module receives data (INF/CDE) associated with the service delivered by the device.

3. A method according to claim 1, characterized in that the modules are electrically powered and in that the control elements (GRS, ACC, CT, CLV) are powered selectively as a function of the service delivered by the device.

4. A communication method according to claim 1, characterized in that a control element issues commands at a given rate, and in that the rate at which commands are issued by said control element is modified as a function of the service delivered by the device.

5. A method according to claim 1, characterized in that the device is a data receiver suitable for receiving data representative of a service.

6. A control module (TCD) suitable for controlling a device (DEC) suitable for delivering services, the module comprising a processor and a plurality of control elements suitable for issuing commands, the module being characterized in that it includes receive means suitable for receiving data associated with the delivered service and modification means suitable for modifying its operation as a function of the received data.

7. A computer program suitable for being performed in a control module suitable for controlling a device (DEC) suitable for delivering services, the module comprising a processor and a plurality of control elements suitable for issuing commands, the module being characterized in that it includes receive means suitable for receiving data associated with the delivered service and modification means suitable for modifying its operation as a function of the received data, said program comprising code instructions that, when the program is executed, performs a step of modifying its operation as a function of the service delivered by the device.

8. A management module (MNG) suitable for communicating with a control module suitable for controlling a device suitable for delivering services, the management module being characterized in that it includes means for transmitting data associated with the delivered service, said data being suitable for being taken into account by the control module to modify the behavior of the control module.

9. (canceled)

10. A service platform (PF) suitable for delivering data streams to a device (DEC), the platform being characterized in that it includes a management module suitable for communicating with a control module suitable for controlling a device suitable for delivering services, the management module being characterized in that it includes means for transmitting data associated with the delivered service, said data being suitable for being taken into account by the control module to modify the behavior of the control module.

11. A system including a device (DEC) and a control module (TCD) suitable for communicating with each other via a communication network (RES2), the system being characterized in that it comprises a control module suitable for controlling a device (DEC) suitable for delivering services, the module comprising a processor and a plurality of control elements suitable for issuing commands, the module being characterized in that it includes receive means suitable for receiving data associated with the delivered service and modification means suitable for modifying its operation as a function of the received data and a management module suitable for communicating with a control module suitable for controlling a device suitable for delivering services, the management module being characterized in that it includes means for transmitting data associated with the delivered service, said data being suitable for being taken into account by the control module to modify the behavior of the control module.
